(19) United States
(12) Patent Application Publication
(10) Pub. No.: US 2004/0263668 A1
(43) Pub. Date: Dec. 30, 2004

(54) Solid-state imaging method and apparatus

(76) Inventors: Dong-Han Kim, Osan-si (KR); Sa-Yoon Kang, Seoul (KR)

Correspondence Address: HARNESS, DICKEY & PIERCE, P.L.C., P.O. BOX 8910, RESTON, VA, 20195, US

(21) Appl. No.: 10/865,882

(22) Filed: Jun. 14, 2004

(30) Foreign Application Priority Data
Jun. 18, 2003 (KR) 2003-39525

(51) Int. Cl. H04N 5/225

(52) U.S. Cl. 348/340

(57) ABSTRACT

A solid-state imaging method and apparatus includes a semiconductor chip for image processing, positioned between a solid-state imaging lens and a solid-state imaging semiconductor chip in a vertical direction so that at least a portion of the semiconductor chip for image processing overlaps the solid-state imaging semiconductor chip in a horizontal direction, such that the semiconductor chip does not intercept light irradiated through a solid-state imaging lens to the solid-state imaging semiconductor chip. The solid-state imaging semiconductor chip may be electrically connected to a lower side of the semiconductor chip for image processing and converts the light passing through the solid-state imaging lens into an image signal.

### BACKGROUND OF THE INVENTION

This application claims the priority of Korean Patent Application No. 10-2003-0039525 filed on Jun. 18, 2003 in the Korean Intellectual Property Office, the disclosure of which is incorporated herein by reference.

1. Field of the Invention

The present invention pertains, in general, to a solid-state imaging method and apparatus and, in particular, to a solid-state imaging method and apparatus in the form of a package module including a semiconductor device with a light receiving element and a solid-state imaging lens with the semiconductor device.

2. Description of the Related Art

Recent mobile devices, such as personal display assistants and portable phones, may include camera modules, which are solid-state imaging apparatuses including a solid-state imaging semiconductor chip and a solid-state imaging lens. Of the mobile devices, portable phones including small-sized camera modules have various functions of picking up an image using the camera modules, storing the image as picture data, and transmitting the image to other mobile devices.

The camera modules are being made smaller in accordance with the recent trend of making portable phones or portable personal computers (PC) smaller. Semiconductor device package in which the solid-state imaging lens is provided with a solid-state imaging semiconductor chip have been developed so as to meet the demand for the downsizing of camera modules.

FIGS. 1 and 2 are sectional views schematically illustrating prior art solid-state imaging apparatuses, respectively.

As shown in the camera module of FIG. 1, a solid-state imaging lens 20 and a lens attachment unit 15 to which an infrared (IR) cut filter 25 is attached may be mounted on a printed circuit board (PCB) 10 by an adhesive. A solid-state imaging semiconductor chip 40 includes a photoelectric conversion element group converting light irradiated through the solid-state imaging lens 20 into an image signal, and is positioned on the PCB 10. The solid-state imaging semiconductor chip 40 may be wire-bonded to the PCB 10.

An image processing semiconductor chip 60 may also be wire-bonded to a lower side of the PCB 10. Further, the image processing semiconductor chip 60 may be sealed by a dielectric sealing resin 70 in accordance with conventional transfer-mold technology. The image processing semiconductor chip 60 may function to process an image signal from the solid-state imaging semiconductor chip 40.

In the solid-state imaging apparatus as shown in FIG. 1, the solid-state imaging semiconductor chip 40 is wire-bonded to an upper side of the PCB 10. As a result, it may be necessary to install wire-bonding pads around the solid-state imaging semiconductor chip 40 and on the PCB. However, the wire-bonding pads may limit the reduction of the semiconductor device package. Further, if the image processing semiconductor chip 60 is attached to a lower side of the semiconductor device package, the semiconductor device package becomes thicker, which also may limit the reduction of the semiconductor device package.

FIG. 2 illustrates another type of a prior art camera module. As shown, a solid-state imaging lens 20 and a lens attachment unit 15 to which an IR cut filter 25 is attached are mounted on a PCB 110 with an adhesive. The PCB 110 may include a light receiving hole or be made of a transparent material. A solid-state imaging semiconductor chip 40 includes a photoelectric conversion element group converting light irradiated through the solid-state imaging lens 20 into an image signal, and is positioned under the PCB 110 and at the center of the PCB 110. The solid-state imaging semiconductor chip 40 may be electrically connected to the PCB 110 through electrical connection units 145.

An image processing semiconductor chip 60 may be positioned on an upper side of the PCB 110 and near the light receiving hole of the PCB 110, and may be electrically connected to the PCB 110 through electrical connection units 165.

Because the image processing semiconductor chip 60 is positioned at a lateral side of the semiconductor device package, a length of the semiconductor device package is extended, which also may limit the reduction of the semiconductor device package.

### SUMMARY OF THE INVENTION

Exemplary embodiments of the present invention are directed to a solid-state imaging method and apparatus which provide a smaller semiconductor device package.

In an exemplary embodiment, the present invention is directed to a solid-state imaging apparatus including a printed circuit board (PCB) including a light receiving hole positioned opposite a solid-state imaging lens, a solid-state imaging semiconductor chip electrically connected to a lower side of the PCB and converting light passing through the solid-state imaging lens and the light receiving hole into an image signal, and a first semiconductor chip for image processing, positioned between the solid-state imaging lens and the solid-state imaging semiconductor chip in a vertical direction and so that at least a portion of the first semiconductor chip for image processing overlaps the solid-state imaging semiconductor chip in a horizontal direction, such that the first semiconductor chip does not intercept the light irradiated through the solid-state imaging lens to the solid-state imaging semiconductor chip, electrically connected to an upper side of the PCB, and processing the image signal of the solid-state imaging semiconductor chip.

In an exemplary embodiment, the first semiconductor chip includes an opening through which the light passing through the solid-state imaging lens passes or the first semiconductor chip is arranged around a path through which the light passes. In an exemplary embodiment, the opening is a hole, slot, or other suitably shaped opening. In other exemplary embodiments, the first semiconductor chip may be provided in two or more portions in order to obtain the desired opening.

In another exemplary embodiment, the solid-state imaging apparatus further includes an infrared cut filter positioned opposite to the solid-state imaging lens in the lens attachment unit to allow the light passing through the solid-state imaging lens to pass therethrough.

In another exemplary embodiment, the first and second electrical connection units are metal bumps or solder balls.

In another exemplary embodiment, the first and second electrical connection units are sealed using a dielectric sealing resin.

In another exemplary embodiment, the solid-state imaging apparatus further includes a second semiconductor chip for image processing, positioned between the solid-state imaging lens and the solid-state imaging semiconductor chip in a vertical direction and so that at least a portion of the second semiconductor chip for image processing overlaps the solid-state imaging semiconductor chip in a horizontal direction, such that the second semiconductor chip does not intercept light irradiated through the solid-state imaging lens to the solid-state imaging semiconductor chip, and positioned between a lower part of a lens attachment unit and the first semiconductor chip to be electrically connected to the first semiconductor chip through a third plurality of electrical connection units.

In another exemplary embodiment, the second semiconductor chip includes an opening through which the light passing through the solid-state imaging lens passes, or the second semiconductor chip is arranged around a path through which the light passes.

In an exemplary embodiment, the present invention is directed to a solid-state imaging apparatus, including a first semiconductor chip for image processing, positioned between a solid-state imaging lens and a solid-state imaging semiconductor chip in a vertical direction and so that at least a portion of the first semiconductor chip for image processing overlaps the solid-state imaging semiconductor chip in a horizontal direction, such that the first semiconductor chip does not intercept light irradiated through a solid-state imaging lens to a solid-state imaging semiconductor chip and the solid-state imaging semiconductor chip is electrically connected to a lower side of the first semiconductor chip and converts the light passing through the solid-state imaging lens into an image signal.

In another exemplary embodiment, the first semiconductor chip includes an opening through which the light passing through the solid-state imaging lens passes, or the first semiconductor chip is positioned outside a path through which the light passes. In an exemplary embodiment, the opening is a hole, slot, or other suitably shaped opening. In other exemplary embodiments, the first semiconductor chip may be provided in two or more portions in order to obtain the desired opening.

In another exemplary embodiment, the solid-state imaging apparatus further includes a second semiconductor chip for image processing, positioned between the solid-state imaging lens and the solid-state imaging semiconductor chip in a vertical direction and so that at least a portion of the second semiconductor chip for image processing overlaps the solid-state imaging semiconductor chip in a horizontal direction, such that the second semiconductor chip does not intercept the light irradiated through the solid-state imaging lens to the solid-state imaging semiconductor chip, and positioned between a lower part of the lens attachment unit and the first semiconductor chip to be electrically connected to the first semiconductor chip through a plurality of second electrical connection units.

In another exemplary embodiment, the second semiconductor chip includes an opening through which the light passing through the solid-state imaging lens passes or the second semiconductor chip is positioned outside a path through which the light passes. In an exemplary embodiment, the opening is a hole, slot, or other suitably shaped opening. In other exemplary embodiments, the second semiconductor chip may be provided in two or more portions in order to obtain the desired opening.

In another exemplary embodiment, the present invention is directed to a method of imaging including positioning a solid-state imaging lens to irradiated light, positioning a solid-state imaging semiconductor chip to convert the light passing through the solid-state imaging lens into an image signal, and positioning at least one image processing semiconductor chip between the solid-state imaging lens and the solid-state imaging semiconductor chip in a vertical direction and so that at least a portion of the at least one image processing semiconductor chip overlaps the solid-state imaging semiconductor chip in a horizontal direction, such that the at least one image processing semiconductor chip does not intercept light irradiated through the solid-state imaging lens to the solid-state imaging semiconductor chip.

In another exemplary embodiment, the solid-state imaging semiconductor chip and the at least one image processing semiconductor chip are positioned on a printed circuit board (PCB) including a light receiving hole.

### BRIEF DESCRIPTION OF THE DRAWINGS

Exemplary embodiments of the present invention will be more clearly understood from the following detailed description taken in conjunction with the accompanying drawings, in which:

FIGS. 1 and 2 are sectional views schematically illustrating solid-state imaging apparatuses according to the prior art; and

FIGS. 3 to 6 are sectional views schematically illustrating solid-state imaging apparatuses according to exemplary embodiments of the present invention.

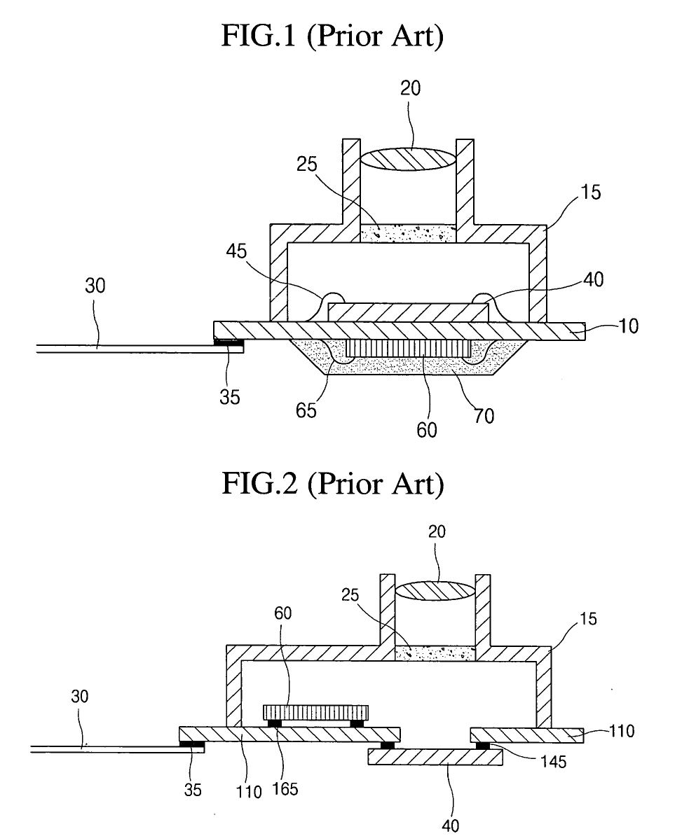

### DESCRIPTION OF EXEMPLARY EMBODIMENTS OF THE PRESENT INVENTION

Reference will now be made in detail to the exemplary embodiments of the present invention, examples of which are illustrated in the accompanying drawings, wherein like reference numerals refer to like elements throughout.

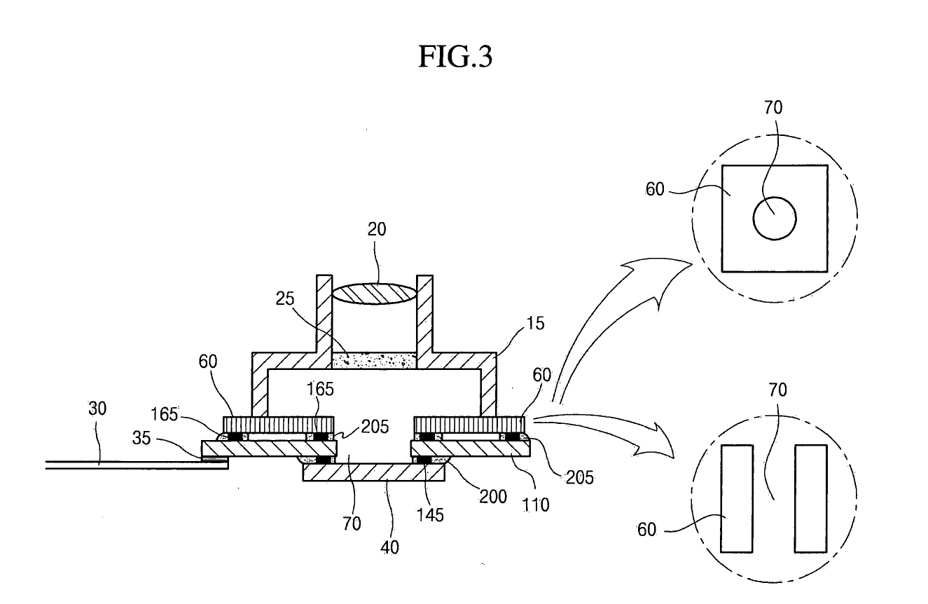

According to an exemplary embodiment of the present invention as shown in FIG. 3, a lower side of a lens attachment unit 15 to which a solid-state imaging lens 20 is attached is mounted on an upper side of a first semiconductor chip 60 for image processing with an adhesive. A light receiving hole 70 positioned opposite to the solid-state imaging lens 20 is formed through a PCB 110, and the PCB 110 is electrically connected to the first image processing semiconductor chip 60 through electrical connection units 165. A solid-state imaging semiconductor chip 40 may include a photoelectric conversion element group converting light irradiated through the solid-state imaging lens 20 into an image signal, and may be electrically connected to a terminal (not shown), positioned under the PCB 10 through a plurality of electrical connection units 145. In an exemplary embodiment, the solid-state imaging apparatus of FIG. 3 further includes an IR cut filter 25 and/or a high frequency cut filter which is attached to the lens attachment unit 15 and positioned opposite to the solid-state imaging lens 20 to allow light irradiated through the solid-state imaging lens 20 to pass therethrough.

The PCB 110 may also be electrically connected to a flexible cable 30 through a cable connection part 35.

The solid-state imaging semiconductor chip 40 may include a photoelectric conversion part (sensor part) having a plurality of photoelectric conversion element groups which constitute a complementary metal-oxide semiconductor (CMOS) image sensor (CIS) arranged in two dimensions, a driving circuit part for sequentially driving the photoelectric conversion element groups to obtain a signal charge, an A/D converter for converting the signal charge into a digital signal, a signal processing part for converting the digital signal into an image signal output, and a semiconductor circuit part in which an exposure control unit electrically controlling an exposure time based on an output level of the digital signal is mounted on the solid-state imaging semiconductor chip 40. The solid-state imaging semiconductor chip 40 may also include a charged coupled device (CCD).

The solid-state imaging apparatus according to exemplary embodiments of the present invention forms a subjective image on a sensor part of the solid-state imaging semiconductor chip 40 through the solid-state imaging lens 20 and IR cut filter 25, thereby performing photoelectric conversion. In other words, the solid-state imaging apparatus may output a digital or an analogue image signal.

The first semiconductor chip 60 may be positioned under the lens attachment unit 15, and may be electrically connected to an upper side of the PCB 110 through a plurality of electrical connection units 165. The first semiconductor chip 60 may function to process an image signal from the solid-state imaging semiconductor chip 40.

The first semiconductor chip 60 may be positioned between the solid-state imaging lens 20 and the solid-state imaging semiconductor chip 40 in a vertical direction and so that at least a portion of the first semiconductor chip 60 overlaps the solid-state imaging semiconductor chip 40 in a horizontal direction, such that the first semiconductor chip 60 does not intercept light which is to be irradiated through the solid-state imaging lens 20 to the solid-state imaging semiconductor chip 40. In an exemplary embodiment, an opening may be formed through the first semiconductor chip 60, or the first semiconductor chip 60 may be located outside a path through which light passes.

A plurality of electrical connection units 145 may be located around an activation region of the solid-state imaging semiconductor chip 40, and may include metal bumps or solder balls. In an exemplary embodiment, the metal bumps may include gold (Au). The solid-state imaging semiconductor chip 40 may be electrically connected to a wiring pattern of the PCB 110 by heat-pressing of the electrical connection units 145. Likewise, the first semiconductor chip 60 may be electrically connected to the PCB 110 by heat-pressing of the electrical connection units 165 formed along the edges of an activation side of the first image processing semiconductor chip 60.

The electrical connection units 145, 165 may be sealed by dielectric sealing resins 200, 205, and the dielectric sealing resins 200, 205 function to improve the reliability of electrically connected parts and reinforce the strength of the electrically connected parts. Examples of the dielectric sealing resins 200, 205 include a dielectric epoxy resin and a dielectric silicon resin.

As shown in FIG. 3, the first semiconductor chip 60 in which an opening is formed is additionally located between the lens attachment unit 15 and PCB 110, thus the width and/or the height of a camera module are reduced in comparison with prior art camera modules in which the semiconductor chips for image processing are attached to a lateral and a lower part of the solid-state imaging semiconductor chip.

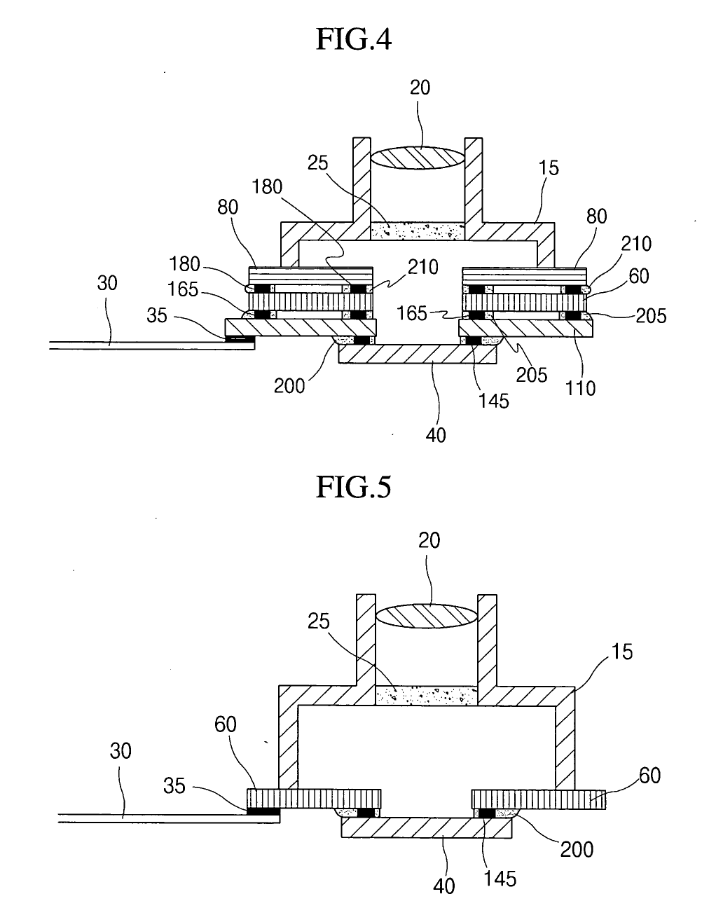

FIG. 4 illustrates a sectional view schematically showing a solid-state imaging apparatus according to another exemplary embodiment of the present invention.

In FIG. 4, a second semiconductor chip 80 for image processing is located between a lens attachment unit 15 and a first semiconductor chip 60. In this regard, the second semiconductor chip 80 is positioned under a lower part of the lens attachment unit 15, and is electrically connected to the first semiconductor chip 60 through the electrical connection units 180. As in FIG. 3, the electrical connection units 180 may include metal bumps or solder balls. In an exemplary embodiment, the metal bumps include gold (Au). The electrical connection units 165, 180 connected to the first semiconductor chip 60 may be electrically connected by wire patterns of metal lines, wire bondings, or via holes in which conductive materials are packed.

The electrical connection units 180 may be sealed by a dielectric sealing resin 210. The dielectric sealing resin 210 may function to improve the reliability of electrically connected parts and reinforce the strength of the electrically connected parts. Examples of the dielectric sealing resins 210 include a dielectric epoxy resin and a dielectric silicon resin.

The second semiconductor chip 80 for image processing may be positioned between the solid-state imaging lens 20 and the solid-state imaging semiconductor chip 40 in a vertical direction and so that at least a portion of the second semiconductor chip 80 overlaps the solid-state imaging semiconductor chip 40 in a horizontal direction, such that the second semiconductor chip 80 does not intercept light which is to be irradiated through the solid-state imaging lens 20 to the solid-state imaging semiconductor chip 40. In an exemplary embodiment, an opening may be formed through the second semiconductor chip 80, or the second semiconductor chip 80 may be located around a path through which the light passes.

As shown in FIG. 4, the second semiconductor chip 80 is located between the first semiconductor chip 60 and the lens attachment unit 15, thus the width and/or the height of a camera module may be reduced in comparison with prior art camera modules, unlike the prior art camera modules in which the semiconductor chips for image processing are attached to a lateral or lower part of the solid-state imaging semiconductor chip.

FIG. 5 illustrates a sectional view schematically showing a solid-state imaging apparatus according to another exemplary embodiment of the present invention.

As shown in FIG. 5, a lower part of a lens attachment unit 15 to which a solid-state imaging lens 20 is attached is attached to an upper side of a first semiconductor chip 60 for image processing, with an adhesive. The first semiconductor chip 60 may be positioned between the solid-state imaging lens 20 and the solid-state imaging semiconductor chip 40 in a vertical direction and so that at least a portion of the first semiconductor chip 60 overlaps the solid-state imaging semiconductor chip 0 in a horizontal direction, such that the first semiconductor chip 60 does not intercept light which is to be irradiated through a solid-state imaging lens 20 to a solid-state imaging semiconductor chip 40. In an exemplary embodiment, an opening may be formed through the first semiconductor chip 60, or the first semiconductor chip 60 may be located outside a path through which the light passes. In an exemplary embodiment, a PCB is not used. In another exemplary embodiment, a wire pattern is formed on any side of the first semiconductor chip 60 and acts as the PCB.

The solid-state imaging semiconductor chip 40 may be positioned opposite to the solid-state imaging lens 20, and electrically connected to a lower side of the first semiconductor chip 60 through a plurality of electrical connection units 145. In an exemplary embodiment, the solid-state imaging apparatus of FIG. 5 may further include an IR cut filter 25 and/or a high frequency cut filter which is attached to the lens attachment unit 15 and positioned opposite to the solid-state imaging lens 20 to allow the light passing through the solid-state imaging lens 20 to pass therethrough.

In an exemplary embodiment, the first semiconductor chip 60 may be electrically connected to a flexible cable 30 through a plurality of cable connection parts 35.

In an exemplary embodiment, the first semiconductor chip 60 may be positioned between the solid-state imaging lens 20 and the solid-state imaging semiconductor chip 40 in a vertical direction and so that at least a portion of the first semiconductor chip 60 overlaps the solid-state imaging semiconductor chip 40 in a horizontal direction, such that the first semiconductor chip 60 does not intercept light which is to be irradiated through the solid-state imaging lens 20 to the solid-state imaging semiconductor chip 40. In an exemplary embodiment, an opening may be formed through the first semiconductor chip 60, or the first semiconductor chip 60 may be located around a path through which light passes.

A plurality of electrical connection units 145 may be located around an activation region of the solid-state imaging semiconductor chip 40, and may include metal bumps or solder balls. In an exemplary embodiment, the metal bumps include gold (Au). A wire pattern may be formed on the first semiconductor chip 60 to act as the PCB, instead of the PCB. An attachment pad of the first semiconductor chip 60 may be positioned to correspond to an attachment pad of the solid-state imaging semiconductor chip 40, and the two attachment pads of the two semiconductor chips 40 and 60 may be electrically connected to each other by heat-pressing the electrical connection units 145.

The electrical connection units 145 may be sealed by a dielectric sealing resin 200, and the dielectric sealing resin 200 may function to improve the reliability of electrically connected parts and/or reinforce the strength of the electrically connected parts. Examples of the dielectric sealing resin 200 include a dielectric epoxy resin and a dielectric silicon resin.

As shown in FIG. 5, the solid-state imaging apparatus may be made smaller by removing the PCB and forming a wire pattern on the first semiconductor chip 60.

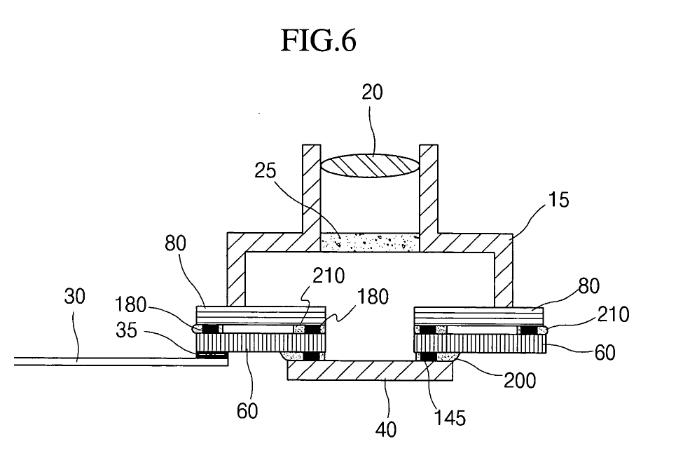

FIG. 6 illustrates a sectional view schematically showing a solid-state imaging apparatus according to another exemplary embodiment of the present invention.

In FIG. 6, a second semiconductor chip 80 for image processing is located between a lens attachment unit 15 and a first semiconductor chip 60 for image processing. In an exemplary embodiment, the second semiconductor chip 80 is positioned under a lower part of the lens attachment unit 15, and is electrically connected to the first semiconductor chip 60 through a plurality of electrical connection units 180. As in the case of FIG. 5, the electrical connection units 180 may include metal bumps or solder balls. In an exemplary embodiment, the metal bumps include gold (Au). The electrical connection units 145, 180 connected to the first semiconductor chip 60 may be electrically connected to each other through wire patterns of metal lines, wire bondings, or via holes in which conductive materials are packed.

The electrical connection units 180 may be sealed by a dielectric sealing resin 210, and the dielectric sealing resin 210 may function to improve the reliability of electrically connected parts and/or reinforce the strength of the electrically connected parts. Examples of the dielectric sealing resin 210 include a dielectric epoxy resin and a dielectric silicon resin.

In an exemplary embodiment, the second semiconductor chip 80 is also positioned between the solid-state imaging lens 20 and the solid-state imaging semiconductor chip 40 in a vertical direction and so that at least a portion of the second semiconductor chip 80 overlaps the solid-state imaging semiconductor chip 40 in a horizontal direction, such that the second semiconductor chip 80 does not intercept light which is to be irradiated through the solid-state imaging lens 20 to the solid-state imaging semiconductor chip 40. In an exemplary embodiment, an opening may be formed through the second semiconductor chip 80, or the second semiconductor chip 80 may be located outside a path through which the light passes.

As shown in FIG. 6, the second semiconductor chip 80 is located between the first semiconductor chip 60 and the lens attachment unit 15, thereby reducing the size of the solid-state imaging apparatus.

As described above, exemplary embodiments of the present invention may be advantageous in that an opening is formed through a semiconductor chip for image processing, and/or the semiconductor chip is layered over a solid-state imaging semiconductor chip, thereby providing a slimmer, smaller solid-state imaging apparatus. Other exemplary embodiments of the present invention may be advantageous in that one or both of semiconductor chips for image processing may be multi-part chips, the multi-parts being arrangeable so they do not intercept light irradiated through a solid-state imaging lens to a solid-state imaging semiconductor chip.

Exemplary embodiments of the present invention have been described in an illustrative manner, and it is to be understood that the terminology used is intended to be in the nature of description rather than of limitation. Many modifications and variations of exemplary embodiments of the present invention are possible in light of the above teachings. Therefore, it is to be understood that within the scope of the appended claims, exemplary embodiments of the invention may be practiced otherwise than as specifically described.

What is claimed is:

1. A solid-state imaging apparatus, comprising:
a printed circuit board (PCB) including a light receiving hole positioned opposite a solid-state imaging lens;
a solid-state imaging semiconductor chip electrically connected to a lower side of the PCB and converting light passing through the solid-state imaging lens and the light receiving hole into an image signal; and
a first semiconductor chip for image processing, positioned between the solid-state imaging lens and the solid-state imaging semiconductor chip in a vertical direction and so that at least a portion of the first semiconductor chip for image processing overlaps the solid-state imaging semiconductor chip in a horizontal direction, such that the first semiconductor chip does not intercept the light irradiated through the solid-state imaging lens to the solid-state imaging semiconductor chip, electrically connected to an upper side of the PCB, and processing the image signal of the solid-state imaging semiconductor chip.

2. The solid-state imaging apparatus as set forth in claim 1, wherein the first semiconductor chip includes an opening through which the light passing through the solid-state imaging lens passes or the first semiconductor chip is positioned outside a path through which the light passes.

3. The solid-state imaging apparatus as set forth in claim 2, further comprising a lens attachment unit to which the solid-state imaging lens is attached and an infrared cut filter, positioned opposite to the solid-state imaging lens in the lens attachment unit, to allow the light passing through the solid-state imaging lens to pass therethrough.

4. The solid-state imaging apparatus as set forth in claim 3, wherein the solid-state imaging semiconductor chip is electrically connected to the lower side of the PCB through a first plurality of electrical connection units and the first semiconductor chip for image processing is electrically connected to the upper side of the PCB through a second plurality of electrical connection units, wherein the first and second plurality of electrical connection units are metal bumps or solder balls.

5. The solid-state imaging apparatus as set forth in claim 4, wherein the first and second plurality of electrical connection units are sealed using a dielectric sealing resin.

6. The solid-state imaging apparatus as set forth in claim 1, further comprising a second semiconductor chip for image processing, positioned between the solid-state imaging lens and the solid-state imaging semiconductor chip in a vertical direction and so that at least a portion of the second semiconductor chip for image processing overlaps the solid-state imaging semiconductor chip in a horizontal direction such that the second semiconductor chip does not intercept light irradiated through the solid-state imaging lens to the solid-state imaging semiconductor chip, and positioned between a lower part of a lens attachment unit and the first semiconductor chip to be electrically connected to the first semiconductor chip through a third plurality of electrical connection units.

7. The solid-state imaging apparatus as set forth in claim 6, wherein the second semiconductor chip includes an opening through which the light passing through the solid-state imaging lens passes or the second semiconductor chip is arranged outside a path through which the light passes.

8. The solid-state imaging apparatus as set forth in claim 7, further comprising an infrared cut filter positioned opposite to the solid-state imaging lens in the lens attachment unit to allow the light passing through the solid-state imaging lens to pass therethrough.

9. The solid-state imaging apparatus as set forth in claim 8, wherein the third plurality of electrical connection units electrically connecting the first semiconductor chip to the second semiconductor chip are metal bumps or solder balls.

10. The solid-state imaging apparatus as set forth in claim 9, wherein the third plurality of electrical connection units electrically connecting the first semiconductor chip to the second semiconductor chip are sealed using a dielectric sealing resin.

11. The solid-state imaging apparatus as set forth in claim 6, wherein at least one of the first and second semiconductor chips is a multi-part semiconductor chip.

12. A solid-state imaging apparatus, comprising:
a first semiconductor chip for image processing; and
a solid-state imaging semiconductor chip, electrically connected to a lower side of the first semiconductor chip, which converts light passing through a solid-state imaging lens into an image signal;
wherein the first semiconductor chip is positioned between the solid-state imaging lens and the solid-state imaging semiconductor chip in a vertical direction and so that at least a portion of the first semiconductor chip overlaps the solid-state imaging semiconductor chip in a horizontal direction such that the first semiconductor chip does not intercept light irradiated through the solid-state imaging lens to the solid-state imaging semiconductor chip.

13. The solid-state imaging apparatus as set forth in claim 12, wherein the first semiconductor chip includes an opening through which the light passing through the solid-state imaging lens passes or the first semiconductor chip is positioned outside a path through which the light passes.

14. The solid-state imaging apparatus as set forth in claim 13, further comprising a lens attachment unit to which the solid-state imaging lens is attached and an infrared cut filter, positioned opposite to the solid-state imaging lens in the lens attachment unit, to allow the light passing through the solid-state imaging lens to pass therethrough.

15. The solid-state imaging apparatus as set forth in claim 14, wherein the solid-state imaging semiconductor chip is electrically connected to the lower side of the first semiconductor chip through a first plurality of electrical connection units, wherein the first plurality of electrical connection units are metal bumps or solder balls.

16. The solid-state imaging apparatus as set forth in claim 15, wherein the first plurality of electrical connection units are sealed using a dielectric sealing resin.

17. The solid-state imaging apparatus as set forth in claim 12, further comprising a second semiconductor chip for image processing, positioned between the solid-state imaging lens and the solid-state imaging semiconductor chip in a vertical direction and so that at least a portion of the second semiconductor chip overlaps the solid-state imaging semiconductor chip in a horizontal direction such that the second semiconductor chip does not intercept light irradiated through the solid-state imaging lens to the solid-state imaging semiconductor chip and positioned between a lower part of a lens attachment unit and the first semiconductor chip to be electrically connected to the first semiconductor chip through a second plurality of electrical connection units.

18. The solid-state imaging apparatus as set forth in claim 17, wherein the second semiconductor chip includes an opening through which the light passing through the solid-state imaging lens passes or the second semiconductor chip is positioned outside a path through which the light passes.

19. The solid-state imaging apparatus as set forth in claim 18, further comprising an infrared cut filter positioned opposite the solid-state imaging lens in the lens attachment unit to allow the light passing through the solid-state imaging lens to pass therethrough.

20. The solid-state imaging apparatus as set forth in claim 19, wherein the second plurality of electrical connection units electrically connecting the first semiconductor chip to the second semiconductor chip are metal bumps or solder balls.

21. The solid-state imaging apparatus as set forth in claim 20, wherein the second plurality of electrical connection units electrically connecting the first semiconductor chip to the second semiconductor chip are sealed using a dielectric sealing resin.

22. The solid-state imaging apparatus as set forth in claim 17, wherein at least one of the first and second semiconductor chips is a multi-part semiconductor chip.

23. A method of imaging, comprising:
positioning a solid-state imaging lens to irradiated light;
positioning a solid-state imaging semiconductor chip to convert the light passing through the solid-state imaging lens into an image signal; and
positioning at least one image processing semiconductor chip between the solid-state imaging lens and the solid-state imaging semiconductor chip in a vertical direction and so that at least a portion of the at least one image processing semiconductor chip overlaps the solid-state imaging semiconductor chip in a horizontal direction, such that the at least one image processing semiconductor chip does not intercept light irradiated through the solid-state imaging lens to the solid-state imaging semiconductor chip.

24. The method as set forth in claim 23, wherein the solid-state imaging semiconductor chip and the at least one image processing semiconductor chip are positioned on a printed circuit board (PCB) including a light receiving hole.

25. The method as set forth in claim 23, wherein the solid-state imaging semiconductor chip and the at least one image processing semiconductor chip are positioned on opposite sides of a printed circuit board (PCB) including a light receiving hole.

26. The method as set forth in claim 23, wherein the solid-state imaging semiconductor chip is positioned on a bottom side of a printed circuit board (PCB) including a light receiving hole and the at least one image processing semiconductor chip is positioned on a top side of the printed circuit board (PCB), closer to the solid-state imaging lens.

27. The method as set forth in claim 23, wherein the at least one image processing semiconductor chip includes an opening through which the light passing through the solid-state imaging lens passes or the at least one image processing semiconductor chip is positioned outside a path through which the light passes.

28. The method as set forth in claim 23, wherein the at least one image processing semiconductor chip is a multi-part semiconductor chip.

29. A method of imaging using a solid-state imaging apparatus, the solid-state imaging apparatus including a solid-state imaging lens to irradiated light, a solid-state imaging semiconductor chip that converts the light passing through the solid-state imaging lens into an image signal, and at least one image processing semiconductor chip for image processing, the method comprising:
positioning the solid-state imaging lens to irradiated the light;
positioning the solid-state imaging semiconductor chip to convert the light passing through the solid-state imaging lens into the image signal; and
positioning the at least one image processing semiconductor chip between the solid-state imaging lens and the solid-state imaging semiconductor chip in a vertical direction and so that at least a portion of the at least one image processing semiconductor chip overlaps the solid-state imaging semiconductor chip in a horizontal direction, such that the at least one image processing semiconductor chip does not intercept light irradiated through the solid-state imaging lens to the solid-state imaging semiconductor chip.
